(19) United States
(12) Patent Application Publication
(10) Pub. No.: US 2024/0378624 A1
(43) Pub. Date: Nov. 14, 2024

(54) ELECTRONIC DEVICE AND METHOD FOR SUSTAINABLE INVESTMENT DATA AND PIPELINE MANAGEMENT

(71) Applicant: Pemberton Holdings, LLC, Lagrangeville, NY (US)

(72) Inventor: Andrew PEMBERTON, Sarasota, FL (US)

(21) Appl. No.: 18/661,247

(22) Filed: May 10, 2024

Related U.S. Application Data
(60) Provisional application No. 63/465,363, filed on May 10, 2023.

(51) Int. Cl. G06Q 30/018; G06Q 40/06

(52) U.S. Cl. CPC G06Q 30/018; G06Q 40/06

(57) ABSTRACT

An apparatus and method for determining whether a company adheres to environmental, social, and governance (ESG) or other sustainability criteria (“ESG factors”) of an investor or investment fund are provided. The method includes receiving, by a processor, one or more ESG factors specified by the investor or investment fund via a user interface; querying, by the processor, one or more databases to retrieve company-specific data by mapping the one or more ESG factors to data identifiers associated with the company; generating, by the processor, an evaluation report by analyzing the retrieved company-specific data to determine a degree of adherence to the ESG criteria; and transmitting, by a communication module, the evaluation report to an external device or a storage medium.

### PRIORITY

This application claims priority under 35 U.S.C. § 119 to Provisional Application No. 63/465,363, filed in the U.S. Patent and Trademark Office on May 10, 2023, the entire content of which is incorporated herein by reference in its entirety.

### BACKGROUND

### 1. Field

The present disclosure relates generally to a device and method for data management, data retrieval, and data processing.

### 2. Description of Related Art

In today's investment market, investors and companies need to meet best practice standards to comply with regulatory frameworks and other industry-mandated or self-imposed investment goals. Traditional customer relationship management (CRM) and pipeline management tools do not provide bespoke solutions to conveniently meet requirements for complying with regulatory frameworks and other self-imposed investment goals. This is particularly true in the field of sustainable investing (e.g., environmental, social, and governance (ESG) investing, impact investing, thematic investing, or other broadly defined ‘responsible investment’ strategies). Existing solution providers offer limited capabilities to meet identified requirements, directly engage with the resulting data for analysis or assessment, and generate necessary reports to demonstrate adherence. These existing solutions may not be suited for the needs of the sustainable investing market.

### SUMMARY

The present disclosure provides an electronic device executing one or more methods implemented using BasisPoint+ (e.g., a proprietary application executed via computer implemented instructions). The one or more methods may help investors and companies identify and adhere to best practice standards for process execution, data analysis, and/or content management for sustainable investing. The one or more methods may enable investors to set up an ESG and impact investing framework for their investment strategy and apply that framework to an investment pipeline and portfolio. Similarly, companies seeking investment can use the tool to set up an ESG and impact investing framework for their business and organize responses to various prospective investors, provide ongoing updates to active investors, and manage internal ESG and impact issues, metrics, and growth milestones. The system, routine and/or method provides a comprehensive process that formalizes documentation, data ingestion/aggregation, data analysis, data assurance, and reporting/disclosure capabilities.

According to an aspect of the disclosure, a computer-implemented method for determining whether a company adheres to ESG or other sustainability criteria (“ESG factors”) of an investor or investment fund, the method comprising receiving, by a processor, one or more ESG factors specified by the investor or investment fund via a user interface; querying, by the processor, one or more databases to retrieve company-specific data by mapping the one or more ESG factors to data identifiers associated with the company; generating, by the processor, an evaluation report by analyzing the retrieved company-specific data to determine a degree of adherence to the ESG criteria; and transmitting, by a communication module, the evaluation report to an external device or a storage medium.

According to another aspect of the disclosure, an apparatus for determining whether a company adheres to ESG or other sustainability criteria (“ESG factors”) of an investor or investment fund is provided. The apparatus includes a processor configured to receive one or more ESG factors specified by the investor or investment fund via a user interface; query one or more databases to retrieve company-specific data by mapping the one or more ESG factors to data identifiers associated with the company; generate an evaluation report by analyzing the retrieved company-specific data to determine a degree of adherence to the ESG criteria; and transmit the evaluation report to an external device or a storage medium.

### BRIEF DESCRIPTION OF THE DRAWINGS

Aspects, features and advantages of the present disclosure will become more apparent from the following detailed description when taken in conjunction with the accompanying drawings in which:

FIG. 1 is a block diagram illustrating a system for sustainable investment and pipeline management, according to an embodiment;

FIG. 2A illustrates a main landing page provided by an electronic device, according to an embodiment;

FIG. 2B illustrates a due diligence questionnaire provided by an electronic device, according to an embodiment;

FIG. 2C illustrates a disclosure frameworks screen provided by an electronic device, according to an embodiment;

FIG. 3 illustrates a dashboard system provided by an electronic device, according to an embodiment;

FIG. 4 illustrates a dashboard system provided by an electronic device, according to an embodiment;

FIG. 5 illustrates a dashboard system provided by an electronic device, according to an embodiment;

FIG. 6 illustrates a due diligence questionnaire screen provided by an electronic device, according to an embodiment;

FIG. 7 illustrates an approval page provided by an electronic device, according to an embodiment;

FIG. 8 illustrates an approval page provided by an electronic device, according to an embodiment; and

FIG. 9 is a block diagram illustrating an electronic device in a network environment, according to an embodiment.

### DETAILED DESCRIPTION

The present application is directed to a technical solution for the complex problem of integrating, analyzing, and managing diverse data types and sources to ensure ESG compliance across multiple platforms in real-time. Unlike conventional systems which fail to provide dynamic, real-time integration and analysis of disparate data sources, the claimed solution utilizes advanced algorithms for data ingestion, correlation, and real-time processing. This ensures that investment firms can accurately and efficiently evaluate ESG compliance, thereby improving the technical field of data management systems.

The system may utilize a customized ESG compliance engine that integrates data from both internal databases and external sources including public domain and proprietary data repositories and tools. This engine may employ a unique algorithmic structure that quantitatively and qualitatively assesses performance of a company against set ESG criteria, adjusting investment recommendations based on real-time data updates. This capability improves upon traditional static investment related analysis tools (e.g., ESG investment tools), providing a dynamic and responsive tool that adapts to new data and regulatory changes in the ESG field.

The technical solution may be realized by an electronic device that executes computer implemented instructions to perform one or more methods using the BasisPoint+ application, thereby providing a proprietary management process for sustainable investing. The application can be stored on various types of storage devices, such as hard disk drives, solid-state drives, universal serial bus (USB) drives, memory cards, or cloud storage devices, and can communicate with electronic devices such as computers, smartphones, laptops, tablets, servers, and the like. The management process for sustainable investing may be executed as instructions by a processor or a controller of the electronic device. The instructions can cause the electronic device to provide a web-based application to the user. The application may be used to perform one or more methods to enable the user to input data to generate documentation and measurement data. The documentation and measurement data may be generated based on stored data, third-party licensed data, public domain data, and user input data, and can be transmitted to an external electronic device.

The BasisPoint+ application offers a proprietary approach to meet industry and regulatory regimes for management and disclosure of key business processes and performance. In addition, the application may be used to implement one or more routines to provide data ingestion and aggregation capabilities, which include direct ingestion within the platform, mobile app updates, and external data sources through files, application programming interfaces (APIs), and other databases. Data within the tool (e.g., application) can also be extracted to interact with external data analytics systems. This results in a custom dataset for improved analytics capabilities. The application provides dynamic dashboards for data visualization that include the capability to join and layer data across the data sources; aggregate and transform the data through calculations, and then drill down from aggregated data visualizations to underlying data points (for example, from the fund/portfolio level data aggregation to specific company/asset data aggregations, to specific data inputs by issue area, goal, or metric associated with that company/asset, and so on). Data trends can be analyzed over time to obtain data trend results, which can be stored in a memory, and the results can be compared to anonymized benchmarks along several characteristics, including industry, issue area, geography, investment/company size, and more.

The one or more methods implemented by the application may enable reporting and disclosure features to be customized to meet the requirements of individual investors and companies. For example, after execution of the application, a graphical user interface may display issue areas, metrics, and/or reporting standards. A user may use the graphical user interface to select which issue areas and metrics are relevant to them and which reporting standards they must meet based on relevant guidance. Issue areas and metrics are tagged to various reporting standards when relevant, so that data can quickly be sorted and categorized based on applicable reporting formats, which may be stored in memory or received from an external device. Templates are provided for predefined reporting standards for users to export results to convenient external file formats (e.g., CSV, PDF, XLS, etc.).

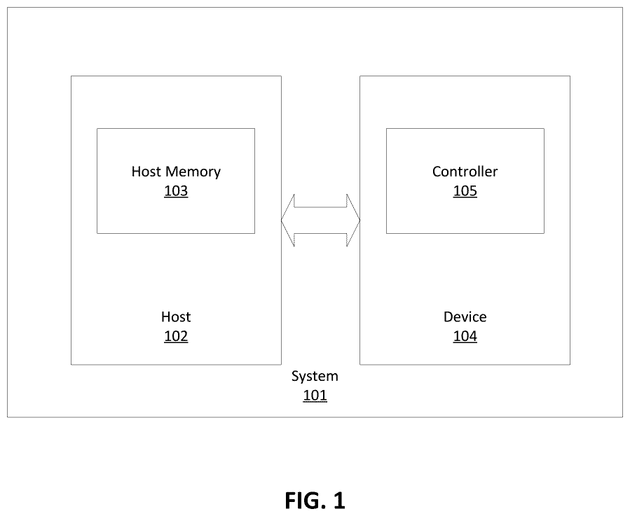

FIG. 1 is a block diagram illustrating a system for sustainable investment and pipeline management, according to an embodiment.

Referring to FIG. 1, the system, designated as system 101, comprises a host 102 and a device 104, which are configured to communicate with each other to facilitate the assessment of ESG criteria compliance. This architecture supports the implementation of a computer-implemented method.

Host 102 includes host memory 103, which serves as a repository for storing various types of data, including but not limited to sets of ESG factors specified by investment funds, company-specific data corresponding to these factors, and benchmarks for compliance assessment. The host memory 103 also stores instructions that, when executed by the processor of host 102, perform steps such as receiving ESG factors via a user interface, querying databases, and generating evaluation reports.

Device 104 includes a controller 105, which is responsible for managing the data retrieval process from one or more databases. Controller 105 executes advanced queries using a specialized query engine. These queries are dynamically adjusted based on, for example, real-time updates to ESG factors received from host 102. The controller 105 ensures that the data retrieved is accurate, up-to-date, and correctly mapped to the corresponding ESG factors for subsequent analysis.

The communication (e.g., via a communication module) between host 102 and device 104 allows for a seamless data flow and real-time updates between the components of the system. This interconnectivity ensures that the analytical processes carried out by the host 102 are based on the most current and relevant data provided by device 104. Such architecture not only supports robust data processing capabilities but also enhances the system's efficiency in generating comprehensive ESG compliance evaluation reports.

The integration of host memory 103 and controller 105 within system 101 can be used to implement a multi-dimensional assessment of ESG criteria alignment across one or more investment funds. This setup supports advanced analytical capabilities, including predictive analytics, natural language processing, and/or statistical modeling. Additionally, the system is configured to incorporate user feedback (e.g., via a company questionnaire) directly into the ongoing optimization of the query and analysis processes, enabling a dynamic and adaptive ESG assessment tool.

This system architecture thus provides a technologically advanced solution for investment firms seeking to navigate the complexities of ESG compliance in a systematic and data-driven manner.

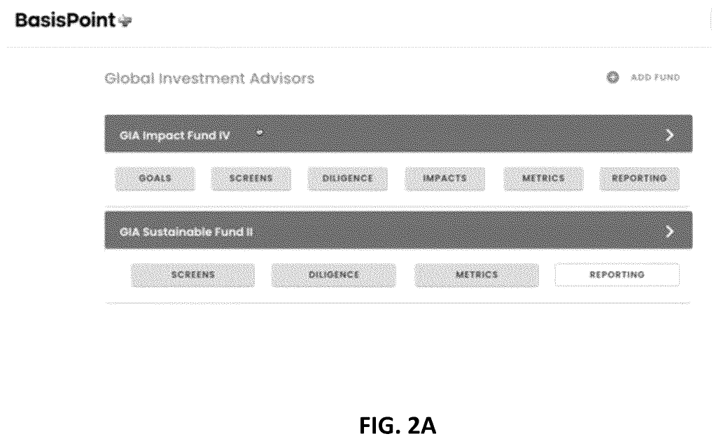

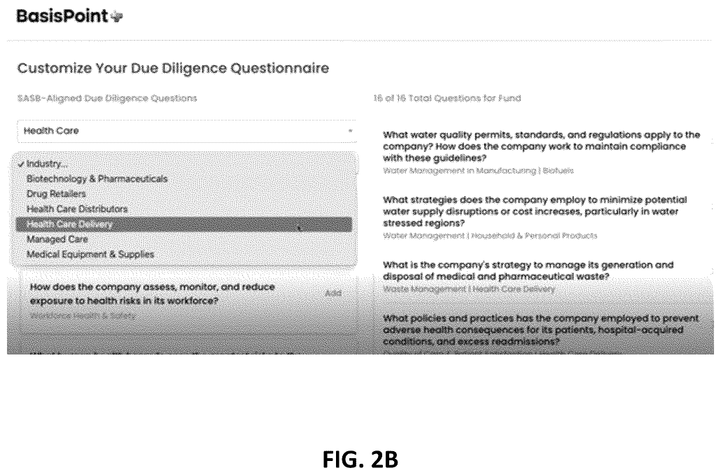

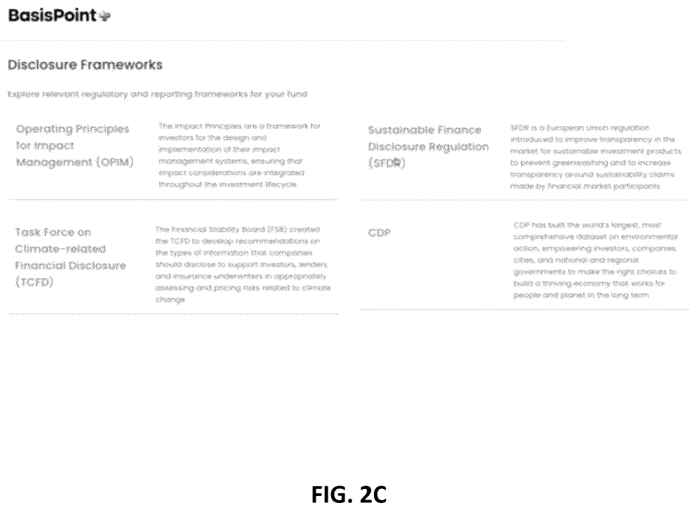

FIG. 2A illustrates a main landing page provided by an electronic device, according to an embodiment.

The electronic device (e.g., device 104) may provide a main landing page, as shown in FIG. 2A, that shows all of the funds an investment firm may manage, and within each fund's dedicated page, a dashboard that summarizes data related to its deal pipeline and portfolio companies. As used herein, the term “investment firm” means a user of the electronic device described in this application. An individual may be a user.

FIG. 2A illustrates, as an example, an investment firm's two funds: GIA Impact Fund IV and GIA Sustainable Fund II. Below each of the funds is a set of data input templates (“goals”, “screens”, “diligence”, etc.). The data input information is used to populate a workflow and dashboard system that (as explained below) enables a user to manage a portfolio and pipeline of investments. The data input information may affect what information is transmitted to and displayed by the dashboard system. For example, if the “diligence” strategy input information button shown in FIG. 2A is selected, a due diligence questionnaire template, as shown in FIG. 2B, may be displayed.

FIG. 2B illustrates a due diligence questionnaire provided by an electronic device, according to an embodiment.

The due diligence questionnaire is displayed by the electronic device and is a set of potential questions and metrics suggested by the platform based on proprietary or licensed intellectual property (IP) to assess the sustainability-related risks and opportunities for potential investment opportunities. The fund manager selects relevant questions which are suggested based on their investment strategy and the relevant industry, or can input their own custom questions. Data can be input as responses to the questions and other metrics by the fund manager or by another party (i.e., a prospect/portfolio company). These responses are used to identify companies that fit the fund's investment objectives and to address areas of risk or identify opportunities for new markets and products. The questionnaire template and workflow helps ensure compliance with industry and regulatory requirements and mitigate potential fines, penalties, or regulatory actions.

The due diligence questionnaire in FIG. 2B provides a first selection item and a second selection item. The second selection item may be provided as a list that is generated based on the selection of the first selection item. For example, if “health care” is selected in the first selection item, then “biotechnology & pharmaceuticals, drug retailers, etc.” may be selected as the second selection item in response to “health care”. Answers to the questions provided on the due diligence questionnaire (as well as other data input questionnaires for each fund) may be used to generate a new dataset of qualitative and quantitative engagement areas, targets, or goals for the responding prospect/portfolio company. The new dataset may be compiled with investment information to generate a dashboard that enables a user to determine the degree to which a fund complies with predetermined and user-generated frameworks.

Providing accurate and complete information in questionnaires, such as those shown in FIG. 2B, allow a fund manager to easily screen their pipeline or manage a set of investments, and understand how one or both align with fund goals, determined in response to the information provided to the questionnaire, in combination with any third-party data the user has imported to create the dataset.

FIG. 2C illustrates a disclosure frameworks screen provided by an electronic device, according to an embodiment.

FIG. 2C illustrates an example of a screen (e.g., a webpage) that may be displayed by the electronic device if the “reporting” button is selected in FIG. 2A.

As shown in FIG. 2C, several disclosure frameworks are listed. These disclosure frameworks (e.g., the European Union's Sustainable Finance Disclosure Regulation) ensure that fund managers can determine if they satisfy requirements for managing non-financial considerations alongside financial metrics. Both regulatory and non-regulatory frameworks are considered, which place a strong emphasis on data aggregation and validation/verification, as well as the consistency of the process for collecting, analyzing, and reacting to data collected. The present application provides systems, processes and methods for aggregating fund and sustainability-related data to allow users to easily comply with such frameworks.

The disclosure frameworks are data sets and may be stored on a local storage device, a network storage device, or an external storage device, and may be requested when an input is received by the electronic device corresponding to the data set (e.g., when a user selects a button corresponding to the data set). Upon request of the framework, data is transmitted from a storage device and displayed on the electronic device. The disclosure data sets may be used to generate a document and sent to a second electronic device. The document may combine the disclosure data with other information input by the user (e.g., information based on a selected framework or investment goal) and/or investment information that is stored on a local storage device, a network storage device, and/or an external storage device.

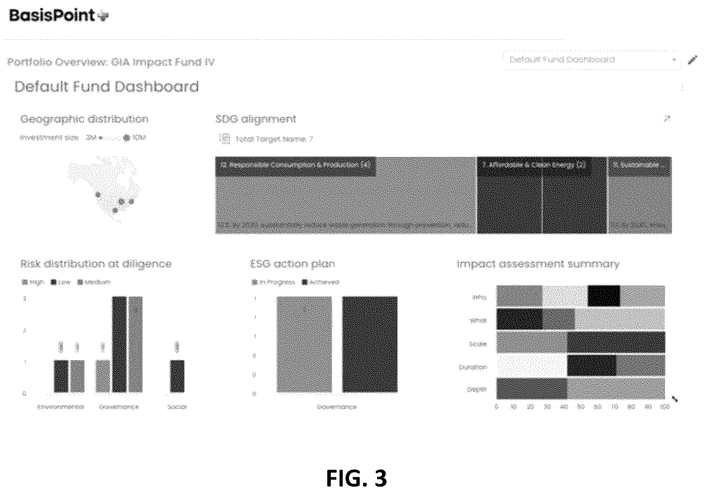

FIG. 3 illustrates a dashboard system provided by an electronic device, according to an embodiment.

FIG. 3 provides a dashboard system (a “homepage”) displayed on an electronic device for a user (e.g., an investment firm) to manage and/or analyze a portfolio and pipeline of investments. The dashboard system provides a centralized location for investment firms (e.g., users) to manage all of their data related to their investments and pipeline. In addition, each homepage may be unique to a fund. For example, one investment firm may have 4 funds, and each fund may have a separate dashboard homepage aggregating unique investment and pipeline entities.

FIG. 3 provides access to a geographic distribution of companies in a fund and displays objects relative to size of investment (top left corner of FIG. 3). The dashboard may display the investment names, locations, and relative investment size in terms of dollar amount.

FIG. 3 provides a summary of an industry goal-setting framework, the Sustainable Development Goals (SDGs), (top right corner of FIG. 3) that investors use to align the activities and outputs of their fund investments. The system used to display such objects is interactive and provides users the capability to manipulate and interact with the charts. For example, a user may click on each SDG to see the underlying data that shows which companies are aligned to the selected SDG and that SDG's corresponding SDG targets and metrics.

The dashboard also includes an impact metrics or ESG risk analysis and distribution display (bottom left of FIG. 3), which provides a similar interactive disaggregation capability for ESG topics which may be associated with companies, activities, or other datasets and may be designated as low, medium, or high risk within the portfolio.

The dashboard is fully customizable to manipulate data in the system, creating new visualizations based on one or many data sets available through the tool. The data that appears on the dashboard may be a combination of user input information and external data (e.g., licensed data). The external data may be stored on a local storage device or a network storage device. The external data is interchangeable and can be requested from a storage device. User input data and external data may be interchangeable. For example, the user can upload a data file to be stored on the local or network storage device, and information included on the data file can be requested and used to populate the dashboard. In addition, a user may also be able to connect an external API to provide data to the dashboard.

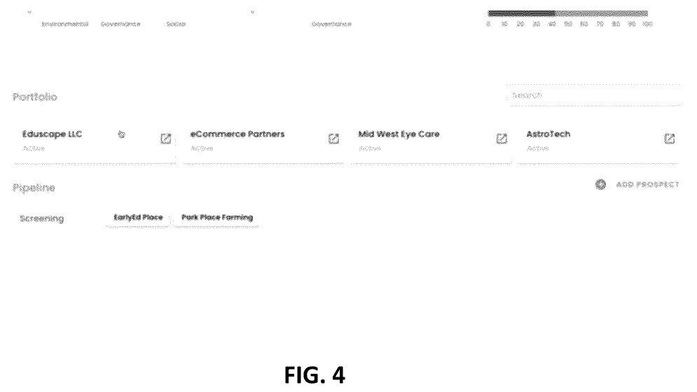

The dashboard (FIG. 3) provides a system to organize companies into a portfolio section, that displays each portfolio company in a fund, as shown below in FIG. 4.

FIG. 4 illustrates a dashboard system provided by an electronic device, according to an embodiment.

The dashboard system illustrated in FIG. 4 may be in addition to the dashboard system of FIG. 3. Some or all of the components of one or more of the embodiments may be combined or omitted.

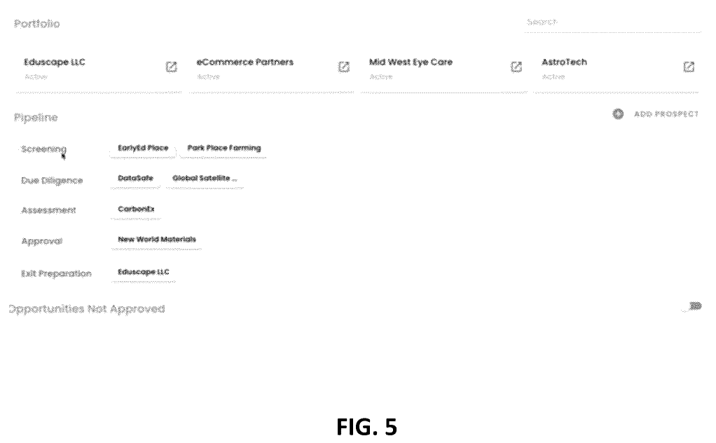

FIG. 5 illustrates a dashboard system provided by an electronic device, according to an embodiment.

The dashboard system illustrated in FIG. 5 may be in addition to the dashboard system of FIGS. 3-4. Some or all of the components of one or more of the embodiments may be combined or omitted.

Similarly, the dashboard shown in FIG. 5 provides a system for organizing prospective investments into a pipeline with distinct categorizations, each with data input and analysis structures.

Each item on the portfolio and pipeline menus shown in FIGS. 4-5 populates to include different capabilities that investment firms should follow to align with best practices and industry reporting frameworks that might be a part of, for example, portfolio management or a due diligence stage of the investment process for qualifying companies/groups/funds to invest in. For example, investment firms might look at 100 to 200 companies and need to follow consistent steps to narrow this initial list down to 10 that they want to analyze in more detail. The system may provide the company with a set of questions (e.g., a questionnaire) to collect information that investment firms can use to quickly screen a company and see if it passes or fails the screen (e.g., if the company fits with the investment firms' framework and/or investing goals).

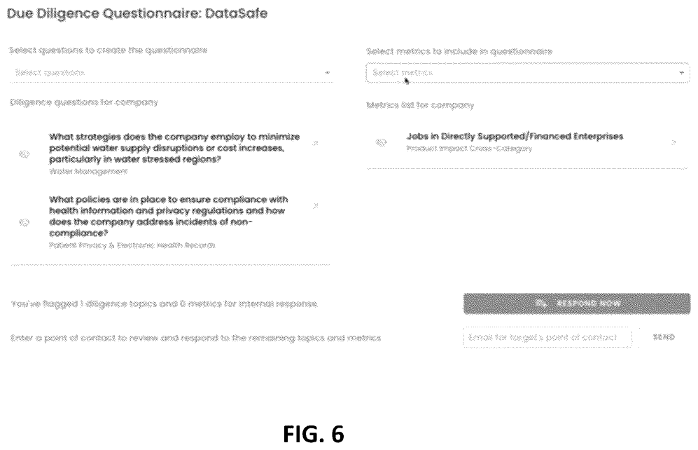

Each list item on the menu represents a unique process and/or data collection step. For example, if “due diligence” is selected in FIG. 5, then FIG. 6 may be displayed.

FIG. 6 illustrates a due diligence questionnaire screen provided by an electronic device, according to an embodiment.

Referring to FIG. 6, after selecting “due diligence”, investment firms may have a series of questions and metrics that populate based on prior data inputs, including the prospective company's industry and custom selections chosen for the fund. FIG. 6 provides the ability to create a questionnaire that investment firms can send to counterparties (e.g., companies) to collect and/or document responses.

The sections titled “Select questions to create the questionnaire” and “Select metrics to include in questionnaire” may be populated by frameworks licensed from a third party or from proprietary IP. The due diligence data that is obtained from the third party may be stored on a local server or may be received from the third party at the time the due diligence page is accessed and the questionnaire is populated. Therefore, an investment firm may request to access due diligence questions from using a first electronic device. The due diligence questions may be sent from a second electronic device to the first electronic device upon receiving the due diligence request. The investment firm may either provide responses to the received due diligence questions using the first electronic device, or may generate a questionnaire based on the received due diligence questions. The investment firm may send the questionnaire from the first electronic device to a third electronic device to enable a company to complete and provide answers to the questionnaire that was generated based on the due diligence questions received by the first electronic device from the second electronic device. The third electronic device may transmit the due diligence questionnaire to the second electronic device or the first electronic device after it is completed.

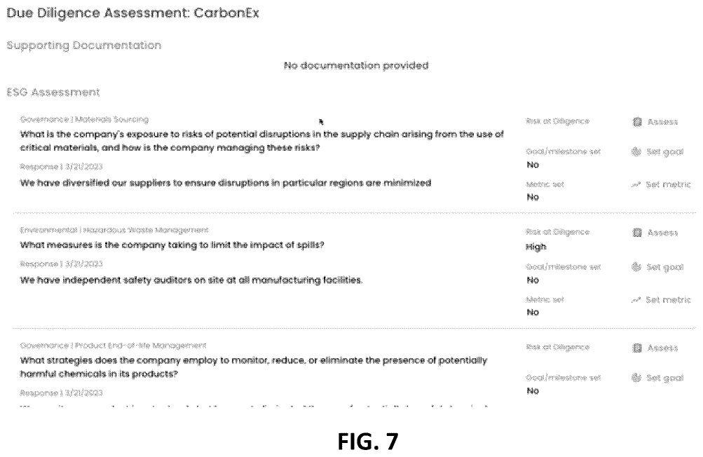

FIG. 7 illustrates an approval page provided by an electronic device, according to an embodiment.

As shown in FIG. 7, once investment firms receive answers to the due diligence questions, investment firms can view the questions they've asked, the responses that they've received (from prospective or active portfolio companies), any documents that were uploaded to support the responses, and then assess each question topic by providing it with a weighted risk value (e.g., high, medium or low risk). Investment firms can set qualitative goals against any topic to build into their business case for a defined amount of time (e.g., a year or six months). Investment firms can set a quantitative metric to track specific progress on a topic over time, which includes setting a baseline or current state value, a quantitative target against that value, and a target end date(s), with the intent to help improve a quality control indicator, such as greenhouse gas emissions, for example. Additionally, the application may automatically track specific progress against the chosen target, a designated benchmark value, or another data assurance mechanism. For example, at a first time instance the application may evaluate whether a first quantitative metric is equal to or greater than a first quantitative target at the first time instance. At a second time instance, the application may evaluate whether the first quantitative metric is equal to or greater than a second quantitative target at the second time instance. The value of the first quantitative metric may change over time. If a difference in value between the first quantitative metric and the first quantitative target is greater than a predetermined threshold (or if a difference in a rate of change between a difference in value between the first quantitative metric and the first quantitative target at the first time instance and a difference in value between the first quantitative metric and the second quantitative target at the second time instance), the application may provide a notification to a user. For instance, an investment firm may be notified that a particular company in their fund's portfolio has not satisfied a predetermined target performance threshold. The investment firm may automatically or manually modify the particular fund based on the notification by, for example, engaging with a particular fund holding (e.g., prospective investments or portfolio companies) to influence performance against the target or replacing a fund holding with another prospective holding that better suits an objective (e.g., increases the likelihood that differences between quantitative metrics and quantitative targets will be less than a predetermined amount).

Furthermore, a combination of quantitative metrics may be simultaneously tracked (e.g., by calculating a distinct value based on two or more quantitative metrics). For instance, a first quantitative metric and a second quantitative metric can be tracked at a first time instance, and the first quantitative metric and the second quantitative metric can be tracked at a second time instance. A difference in value of the first quantitative metric or the second quantitative metric, or a calculation resulting thereof, at the first or second time instance and a predetermined target can be used to determine whether to send a notification to a user and/or modify a particular fund based on the notification.

In addition, a user (e.g., an investor or investment fund) can generate one or more frameworks, datasets, or output criteria and apply it to one or more contexts (e.g., a company can create a dataset by answering questions, and then use that one dataset to be queried by multiple investors rather than creating separate datasets for each investor they engage).

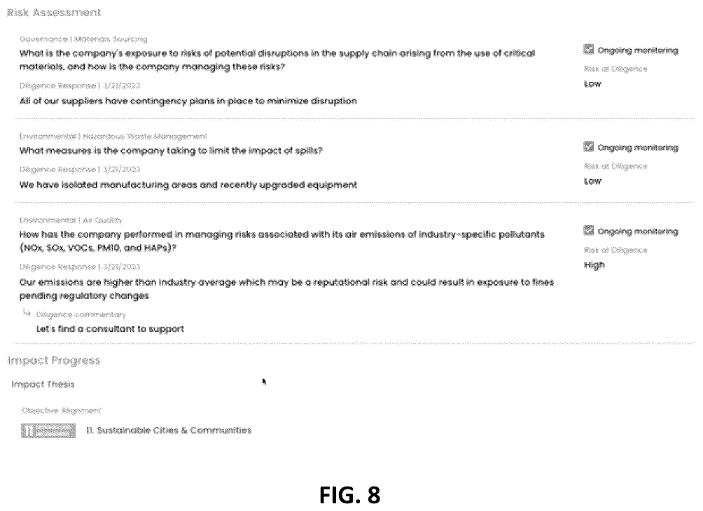

FIG. 8 illustrates an approval page provided by an electronic device, according to an embodiment.

Referring to FIG. 8, once an assessment of a company based on the data responses is complete, the approval page may be provided. The approval page is used to review and approve responses and resulting analyses for the prospective investment's inclusion in an investment fund's portfolio. It may serve as documentation for what was presented to an investment committee for approval and as input to fulfillment of industry and regulatory disclosure requirements. The page also includes a method for reviewing progress made on sustainability-related topics and metrics over the life of an investment to include in a business case when the investment is preparing to be sold or exited.

The approval page is designed to provide a comprehensive assessment of investment targets and track progress on sustainability-related topics. The approval page includes a questionnaire that enables investors to evaluate potential investments based on user input and industry frameworks. The page also allows investors to set qualitative and quantitative goals to track progress over time. The approval page further includes statistics and guidance that investors can use to inform their decision to approve or reject inclusion of an investment in the portfolio. Additionally, the approval page can be used as a part of an exit package that investors prepare when they exit their position, which helps build a business case for a follow-on investor and highlights the progress made on sustainability-related topics. The approval page is flexible and can ingest different data sources, including user input and external APIs, to provide combined analytics.

As described above, the present application proposes an electronic device and method of using the electronic device for collecting and analyzing sustainability data related to making and managing investments, and systematizing pipeline management to adhere to self-imposed and regulatory disclosure requirements. According to an embodiment, the method may include displaying a first screen on the electronic device including one or more frameworks configured to customize an investment firm's context; obtaining user input information in response to a user selection of at least one of the frameworks; applying the user input information to investment fund information (e.g., criteria or objectives) to identify whether a prospective investment is in compliance with framework information or if additional fund information must be met to achieve compliance with the framework. Similarly, aggregate data may be used to determine if the fund as a whole (i.e., the sum of prospective or active investments) is in compliance with fund information or self-imposed and regulatory disclosure requirements. Aggregate information may be calculated by the application itself or by using, at the direction of the user, application features to create formulas that result in the necessary calculation. Therefore, the method is capable of outputting (e.g., transmitting) aggregated compliance information to an external electronic device.

Additionally or alternatively, as described above, the present application proposes an electronic device and method of using the electronic device for collecting and analyzing sustainability data related to making and managing investments, and systematizing pipeline management to adhere to self-imposed and regulatory disclosure requirements. According to an embodiment, the method may include displaying a first screen on the electronic device including one or more questions related to sustainable investing; obtaining second user input information in response to a selection by a first user of at least one of the questions (additionally or alternatively, the second user input information may be obtained in response to a first user input (e.g., writing a custom question)); transmitting questionnaire information, based on the selection by the first user, to another electronic device; receiving, from another electronic device, response information based on a selection by a second user at the other electronic device, wherein the response information is generated based on the selection of the second user and the questionnaire information; applying the questionnaire information to investment fund information (e.g., criteria or objectives) to identify whether a prospective investment is in compliance with framework information or if additional fund information must be met to achieve compliance with the framework. Additional user types and devices may be used to transmit, receive, and analyze information based on permissions users have set or agreed to. For example, users may grant access to service providers that can support them in the execution of the application. Users may also grant access to institutions with which they partner to provide for faster data flow between stakeholders while reducing opportunities for error.

Furthermore, various reports and or information can be presented to a user. For example, the term “evaluation report” may refer to a comprehensive document or digital output that analyzes a company's adherence to specified ESG criteria as determined by investment funds. This report may combine quantitative metrics—such as statistical data on carbon emissions or diversity indices—and qualitative assessments of practices like community engagement and leadership ethics. It may feature a variety of data visualizations, including graphs and heat maps, which provide clear, engaging representations of complex data, enabling users to quickly understand critical insights.

The evaluation report also may include a detailed risk assessment section that identifies and categorizes potential ESG compliance risks and offer strategies for mitigation. Furthermore, it may provide actionable recommendations tailored to the investment fund's specific goals and needs. Content within the report is dynamic, capable of real-time updates to reflect new data or evolving ESG criteria, ensuring that users have access to the most current information for decision-making.

The format of the evaluation report may be customizable, allowing users to adjust the detail level, included sections, and presentation style. Considering the sensitive nature of the data, the report may incorporate advanced security features like encryption and access controls to maintain confidentiality and restrict access to authorized users.

Furthermore, the system may employ a matching function that aligns company-specific data identifiers with various stakeholders in the investment process, including investors, investment funds, other companies, and other pertinent parties. This matching is predicated on the analysis of ESG factors specified either by the investor or the investment fund, or derived from the company-specific data itself.

The matching function may operate by first analyzing the ESG factors to determine relevant attributes or requirements. It may then compare these attributes against a database of user profiles, which includes investors, investment funds, and companies, to identify potential alignments based on ESG criteria. For instance, if an investment fund emphasizes strong governance practices, the system will prioritize matching with companies that exhibit robust governance structures as per the analyzed data.

Furthermore, the matching may extend to other parties that play critical roles in the investment ecosystem. These other parties may include service providers such as consultants who specialize in ESG compliance, legal advisors who ensure adherence to environmental regulations, financial advisors who guide investment strategies based on ESG factors, and data providers who offer access to specialized ESG metrics. Each of these entities can be matched based on their expertise areas corresponding to the specific needs identified through the ESG criteria analysis.

In addition, using the above-mentioned processes, the system is capable of transforming complex regulatory or industry-imposed ESG frameworks into structured business and investment process workflows.

That is, the system may convert intricate regulatory or industry-imposed ESG frameworks into actionable business and investment process workflows through an algorithm executed by the processor. This transformation organizes the workflow into distinct stages tailored to optimize the investment process while ensuring ESG compliance. Initially, during the screening stage, the system utilizes the transformed frameworks to establish criteria for initially screening potential investment opportunities. It collects preliminary data on companies and assesses these against the specified ESG factors to determine suitability for further analysis. This helps in narrowing down the pool of potential investments to those that align with the basic ESG standards set forth by the regulatory or industry frameworks.

Following the initial screening, a due diligence stage involves a deeper analysis of the shortlisted companies. Here, the processor facilitates the collection of detailed information regarding each company's ESG practices and performance. Employing advanced analytical tools, the system scrutinizes each entity against the comprehensive ESG criteria derived from the regulatory frameworks, allowing investment funds to gauge the true ESG impact and compliance of potential investments.

Once investments are made, the monitoring stage ensures ongoing compliance with ESG standards. The processor continuously collects and analyzes data related to the ESG performance of the invested companies against the established frameworks. This continuous monitoring is crucial for maintaining transparency and accountability, providing regular updates that enable timely interventions if ESG standards are not being met.

In each stage, the processor supports the input of data related to ESG factors, essential for accurate analysis and informed decision-making. This structured approach not only simplifies adherence to complex ESG frameworks but also makes the entire investment process more systematic and aligned with regulatory and industry expectations, thereby enhancing the effectiveness and sustainability of investment strategies.

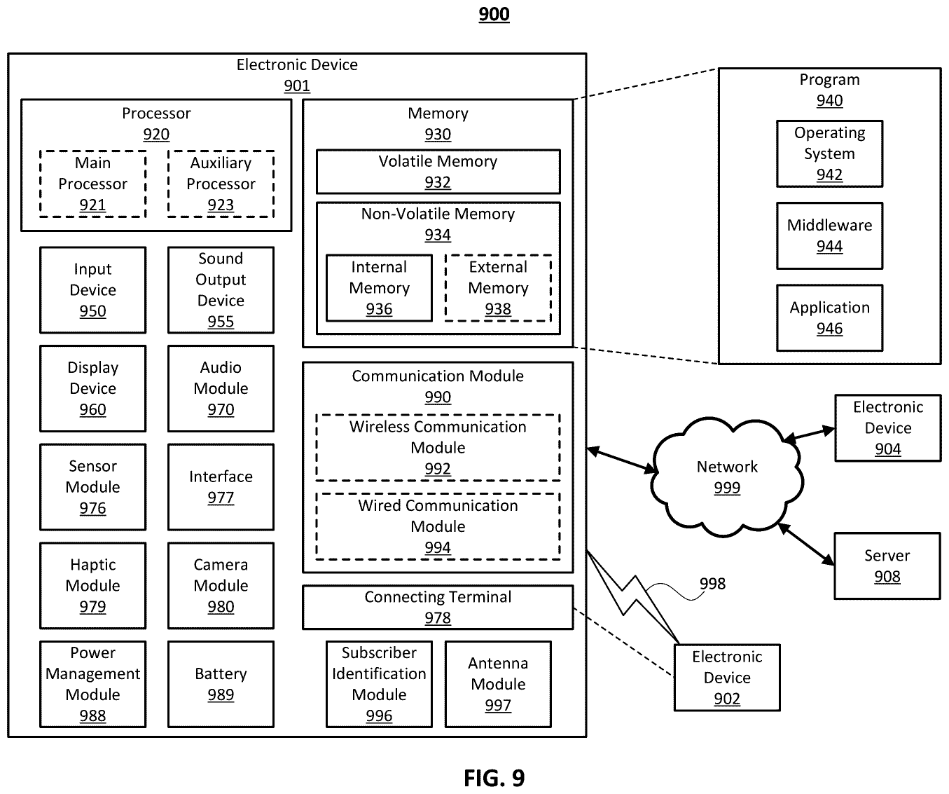

FIG. 9 is a block diagram illustrating an electronic device in a network environment, according to an embodiment.

The electronic device in FIG. 9 may correspond to the host and/or device shown in FIG. 1. Referring to FIG. 9, the electronic device 901 (e.g., host 102 or device 104) in the network environment 900 may communicate with an electronic device 902 (e.g., host 102 or device 104) via a first network 998 (e.g., a communication module such as a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) 996, or an antenna module 997 including a global navigation satellite system (GNSS) antenna. In one embodiment, at least one (e.g., the display device 960 or the camera module 980) of the components may be omitted from the electronic device 901, or one or more other components may be added to the electronic device 901. In one embodiment, some of the components may be implemented as a single IC. For example, the sensor module 976 (e.g., a fingerprint sensor, an iris sensor, or an illuminance sensor) may be embedded in the display device 960 (e.g., a display).

The processor 920 may execute, for example, software (e.g., a program 940) to control at least one other component (e.g., a hardware or a software component) of the electronic device 901 coupled with the processor 920, and may perform various data processing or computations. As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor, and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to one embodiment, the auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by other component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. According to one embodiment, the receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. According to one embodiment, the display device 960 may include touch circuitry adapted to detect a touch, or sensor circuitry (e.g., a pressure sensor) adapted to measure the intensity of force incurred by the touch. The display device 960 may be a UI that graphically displays the BasisPoint+ application to a user.

The audio module 970 may convert a sound into an electrical signal and vice versa. According to one embodiment, the audio module 970 may obtain the sound via the input device 950, or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. According to one embodiment, the interface 977 may include, for example, a high definition multimedia interface (HDMI), a USB interface, a secure digital (SD) card interface, or an audio interface.

A connecting terminal 978 may include a connector via which the electronic device 901 may be physically connected with the external electronic device 902. According to one embodiment, the connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. According to one embodiment, the haptic module 979 may include, for example, a motor, a piezoelectric element, or an electrical stimulator.

The camera module 980 may capture a still image or moving images. According to one embodiment, the camera module 980 may include one or more lenses, image sensors, image signal processors, or flashes.

The power management module 988 may manage power supplied to the electronic device 901. The power management module 988 may be implemented as at least part of, for example, a power management integrated circuit (PMIC).

The battery 989 may supply power to at least one component of the electronic device 901. According to one embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor) and supports a direct (e.g., wired) communication or a wireless communication. According to one embodiment, the communication module 990 may include a wireless communication module 992 (e.g., a cellular communication module, a short-range wireless communication module, or a GNSS communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. According to one embodiment, the antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

According to one embodiment, commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

One embodiment may be implemented as software (e.g., the program 940) including one or more instructions that are stored in a storage medium (e.g., internal memory 936 or external memory 938) that is readable by a machine (e.g., the electronic device 901). For example, a processor of the electronic device 901 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

1. A computer-implemented method for determining whether a company adheres to environmental, social, and governance (ESG) or other sustainability criteria (“ESG factors”) of an investor or investment fund, the method comprising:
receiving, by a processor, one or more ESG factors specified by the investor or investment fund via a user interface;
querying, by the processor, one or more databases to retrieve company-specific data by mapping the one or more ESG factors to data identifiers associated with the company;
generating, by the processor, an evaluation report by analyzing the retrieved company-specific data to determine a degree of adherence to the ESG criteria; and
transmitting, by a communication module, the evaluation report to an external device or a storage medium.

2. The method of claim 1, further comprising transforming, by the processor, one or more regulatory or industry-imposed frameworks into business and investment process workflows which comprise one or more of a screening stage, a due diligence stage, and a monitoring stage, which, together, provide the one or more regulatory or industry-imposed frameworks and data input options to collect and analyze information on ESG factors.

3. The method of claim 1, wherein querying, by the processor, the one or more databases to retrieve company specific data further comprises mapping a first instance of the one or more ESG factors specified by a first investor or investment fund to data identifiers associated with the company and mapping a second instance of the one or more ESG factors specified by a second investor or investment fund to the data identifiers associated with the company.

4. The method of claim 1, further comprising matching one or more of the company-specific data identifiers to one or more other users, including at least one of the investor, the investment fund, another company, or other parties, based on, at least one of, the ESG factors specified by the investor or investment fund or the company-specific data.

5. The method of claim 1, further comprising displaying the evaluation report on a graphical user interface (GUI) that includes interactive elements to manipulate visual indicators representing the degree of adherence to pre-determined parameters and degree of influence on business drivers including for profit and cost.

6. The method of claim 1, wherein querying the one or more databases further comprises accessing both publicly available databases and private databases that require authentication.

7. The method of claim 1, wherein generating the evaluation report further comprises performing statistical analysis of the company-specific data against benchmark data stored in the one or more databases.

8. The method of claim 7, wherein the statistical analysis includes regression analysis to identify trends in the company-specific data over time.

9. The method of claim 1, further comprising updating the one or more databases based on feedback received over one or more points in time from companies regarding the accuracy of the data used in the evaluation report.

10. The method of claim 1, wherein the user interface through which the one or more ESG factors are received allows for customization of the ESG criteria by the investment fund.

11. An apparatus for determining whether a company adheres to environmental, social, and governance (ESG) or other sustainability criteria (“ESG factors”) of an investor or investment fund, comprising:
a processor configured to:
receive one or more ESG factors specified by the investor or investment fund via a user interface;
query one or more databases to retrieve company-specific data by mapping the one or more ESG factors to data identifiers associated with the company;
generate an evaluation report by analyzing the retrieved company-specific data to determine a degree of adherence to the ESG criteria; and
transmit the evaluation report to an external device or a storage medium.

12. The apparatus of claim 11, wherein the processor is further configured to transform one or more regulatory or industry-imposed frameworks into business and investment process workflows which comprise one or more of a screening stage, a due diligence stage, and a monitoring stage, which, together, provide the one or more regulatory or industry-imposed frameworks and data input options to collect and analyze information on ESG factors.

13. The apparatus of claim 11, wherein querying the one or more databases to retrieve company specific data further comprises mapping a first instance of the one or more ESG factors specified by a first investor or investment fund to data identifiers associated with the company and mapping a second instance of the one or more ESG factors specified by a second investor or investment fund to the data identifiers associated with the company.

14. The apparatus of claim 11, wherein the processor is further configured to match one or more of the company-specific data identifiers to one or more other users, including at least one of the investor, the investment fund, another company, or other parties, based on, at least one of, the ESG factors specified by the investor or investment fund or the company-specific data.

15. The apparatus of claim 11, further comprising a graphical user interface configured to display the evaluation report with interactive elements to manipulate visual indicators representing the degree of adherence to pre-determined parameters and degree of influence on business drivers including for profit and cost.

16. The apparatus of claim 11, wherein querying the one or more databases further comprises accessing both publicly available databases and private databases that require authentication.

17. The apparatus of claim 11, wherein generating the evaluation report further comprises performing statistical analysis of the company-specific data against benchmark data stored in the one or more databases.

18. The apparatus of claim 17, wherein the statistical analysis includes regression analysis to identify trends in the company-specific data over time.

19. The apparatus of claim 11, wherein the processor is further configured to update the one or more databases based on feedback received from companies regarding the accuracy of the data used in the evaluation report.

20. The apparatus of claim 11, wherein the user interface through which the one or more ESG factors are received allows for customization of the ESG criteria by the investment fund.
